(19) United States
(12) Patent Application Publication
(10) Pub. No.: US 2010/0248832 A1
(43) Pub. Date: Sep. 30, 2010

(54) CONTROL OF VIDEO GAME VIA MICROPHONE

(75) Inventors: Chris Esaki, Redmond, WA (US); Keiichi Yano, Tokyo (JP)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/414,401

(22) Filed: Mar. 30, 2009

(51) Int. Cl. A63F 13/02

(52) U.S. Cl. 463/36; 463/31

(57) ABSTRACT

Embodiments are disclosed that relate to the control of a microphone-based video game. For example, one disclosed embodiment provides a method of operating a microphone-based video game, wherein the method comprises presenting the video game on a display, receiving one or more motion sensor signals from a microphone comprising a motion sensor, detecting a change of state of the microphone between an in-use state and an inactive state based upon the one or more motion sensor signals received from the microphone, and in response to the change of state of the microphone, changing a number of representations of players displayed in the video game.

### BACKGROUND

Microphone-based video games allow a player to interact with a video game via a microphone. For example, a karaoke game may allow one or more players to sing along with a song and to be scored based upon one or more aspects of the players' performance, such as tone, pitch, timing, accuracy in following lyrics displayed during game play, etc.

Where such games are intended for one or more players, it may be cumbersome a player to join a game while other players are currently playing the game. For example, a player joining mid-game may have to use a handheld controller other than the microphone to navigate through menus or the like before game play resumes with that player added. Such disruptions may discourage potential players from joining a game already in progress. Further, feedback provided during such games, such as cheering by a “virtual audience” in the video game, is generally provided when a player achieves a pre-defined criteria in the game, and is not otherwise initiated by player actions.

### SUMMARY

Accordingly, various embodiments are disclosed herein that relate to the control of a microphone-based video game. For example, one disclosed embodiment provides a method of operating a microphone-based video game, wherein the method comprises presenting the video game on a display, receiving one or more motion sensor signals from a microphone comprising a motion sensor, detecting a change of state of the microphone between an in-use state and an inactive state based upon the one or more motion sensor signals received from the microphone, and in response to the change of state of the microphone, changing a number of representations of players displayed in the video game.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows players interacting with an embodiment of a microphone-based video game environment.

FIG. 2 shows an embodiment of a method of operating a microphone-based video game.

FIG. 3 shows another embodiment of a method of operating a microphone-based video game.

FIG. 4 shows an embodiment of a screen shot of a video game before a second player picks up a microphone.

FIG. 5 shows an embodiment of a screen shot of a video game after the second player picks up a microphone.

FIG. 6 shows another embodiment of a method of operating a microphone-based video game.

FIG. 7 shows a virtual audience responding to microphone motion in an embodiment of a microphone-based video game environment.

FIG. 8 shows a block diagram of an embodiment of a video game system.

### DETAILED DESCRIPTION

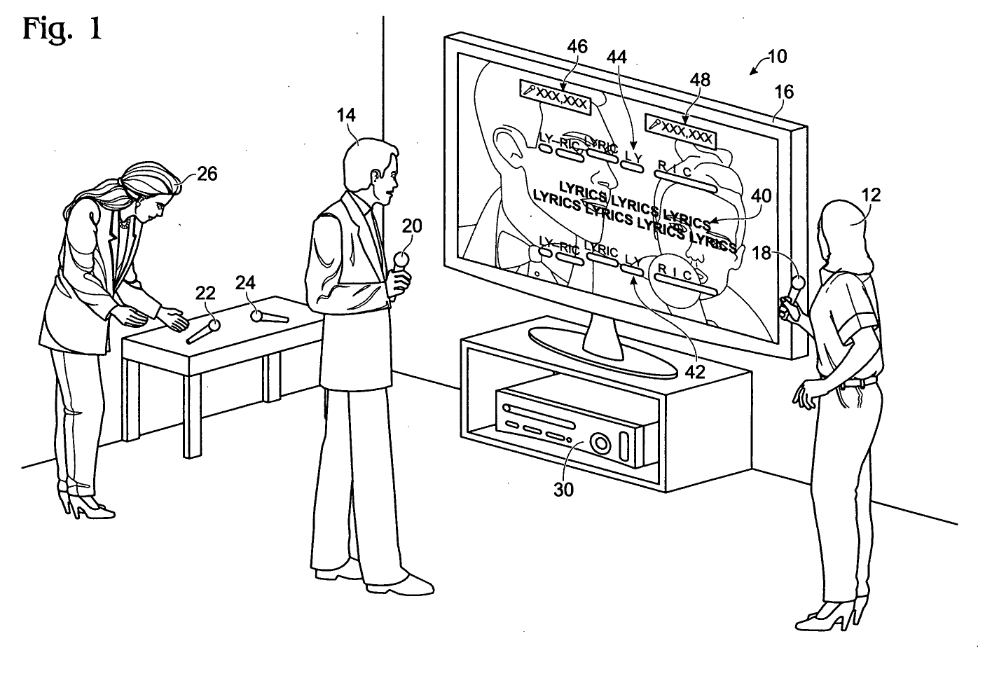

Embodiments are disclosed herein that related to the control of a microphone-based video game via a microphone, rather than via a separate handheld controller, console, or the like. FIG. 1 shows an embodiment of an example microphone-based video game environment 10 in which two players 12, 14 are currently playing a microphone-based video game, such as a karaoke game, displayed on a display 16. Player 12 is holding a first microphone 18, and player 14 is holding a second microphone 20. A third microphone 22 and a fourth microphone 24 are at rest on a table, and an additional player 26 is reaching for the third microphone 22. The depicted microphones 18, 20, 22, and 24 are configured to communicate wirelessly with a video game console 30. However, it will be understood that each microphone also may communicate with the console via a cable (not shown) that connects the microphone to the video game console 30. As will be described in more detail below, each microphone 18, 20, 22 and 24 includes not only an audio transducer for receiving vocal inputs, but also one or more motion sensors for detecting microphone motions. This may allow a player to interact with the video game both by singing and by performing gestures with a microphone.

Referring to the display 16 shown in FIG. 1, a set of lyrics 40 are displayed in a central portion of the display. Further, the lyrics are also displayed on in a first player representation 42 that indicates to the first player 12 how to sing the lyrics, and also in a second player representation 44 that indicates to the second player 14 how to sing the lyrics. Additionally, scores 46 and 48 are shown for the first player 12 and the second player 14, respectively.

In conventional microphone-based games, joining an additional player to a game may involve various steps that are disruptive to the experience of other players currently playing the game. For example, the addition of a new player may involve selecting an “add a player” control from a menu accessible via a control on the video game console 30 or on a handheld controller (not shown) other than a microphone. This may cause a new player to wait until a song selection is over before joining a game, and therefore may discourage new players from joining.

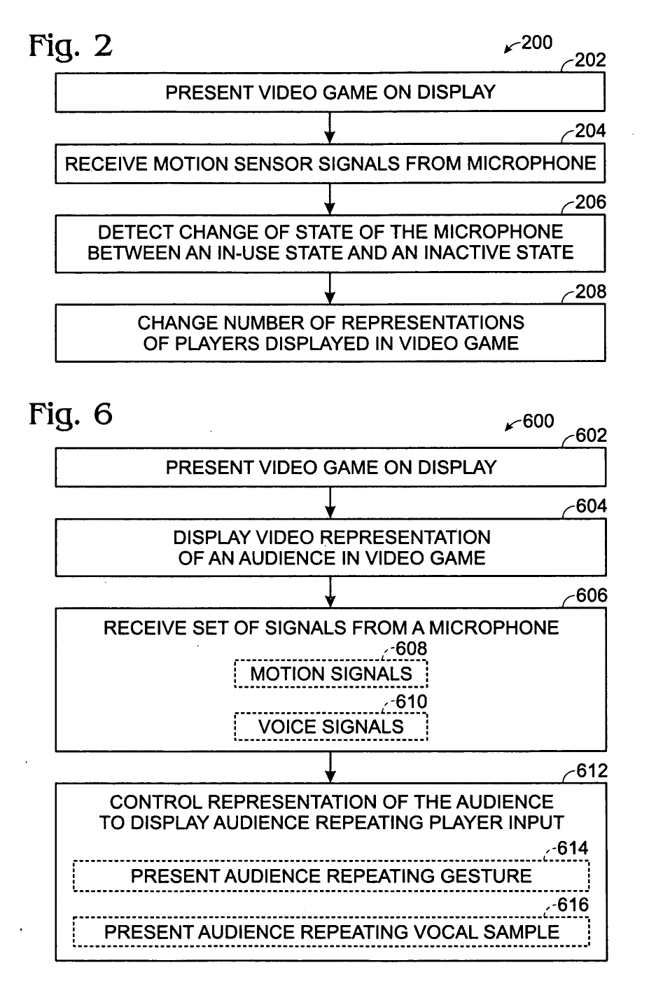

Thus, FIG. 2 shows an embodiment of a method 200 for operating a microphone-based video game that facilitates the addition and/or removal of players to and from the microphone-based video game. Method 200 comprises, at 202, presenting a video game on a display. The video game may be played via a console connected to the display, via a remote network video game server, or in any other suitable manner.

Next, method 200 comprises, at 204, receiving a set of motion signals from a motion sensor on the microphone. The set of motion signals may comprise, for example, a set of signals that represents a microphone being lifted from a surface after a period of inactivity, being lifted and then shaken, being set down onto a surface after a period of activity, or any other suitable combination of motion events.

In response to the set of motion sensor signals received from the motion sensor on the microphone, method 200 next comprises, at 206, detecting a change of state of the microphone between an in-use state and an inactive state. For example, where the set of motion sensor signals represents a microphone being lifted from a surface after a period of inactivity, or lifted and then shaken after a period of inactivity, etc., it may be determined that the microphone has changed from an inactive state to an in-use state. Likewise, where the set of motion sensor signals represents a microphone being placed onto a surface and then left at rest for longer than a threshold period, then it may be determined that the microphone has changed from an in-use state to an inactive state. It will be understood that these motion patterns are disclosed for the purpose of example, and are not intended to be limiting in any manner.

In response to detecting the change of state of the microphone between an in-use state and an inactive state, method 200 next comprises, at 208, changing a number of representations of players displayed in the video game. For example, if it is determined that a change from an inactive state to an in-use state has occurred, then a representation of a player may be added to the video game. Likewise, if it is determined that a change from an in-use state to an inactive state has occurred, then a representation of a player may be removed from the game. In this manner, players may join and leave a microphone-based video game simply by performing a gesture with the microphone, where the gesture may be as simple as lifting the microphone from a surface, lifting and then shaking the microphone, by placing a microphone down on a surface, or any other suitable gesture or combination of gestures that follows a period of inactivity.

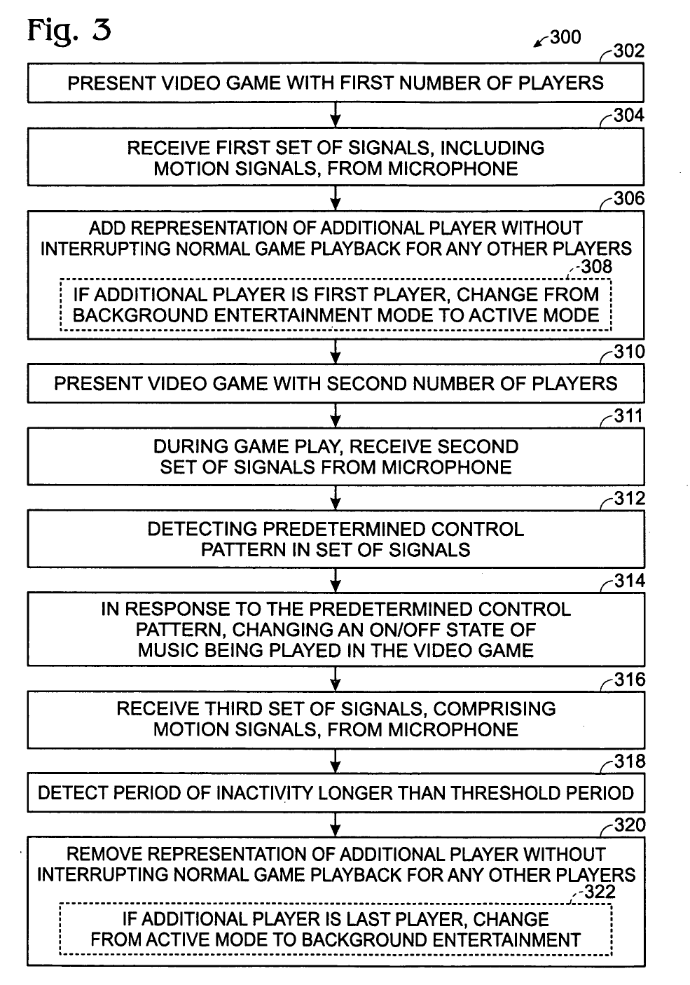

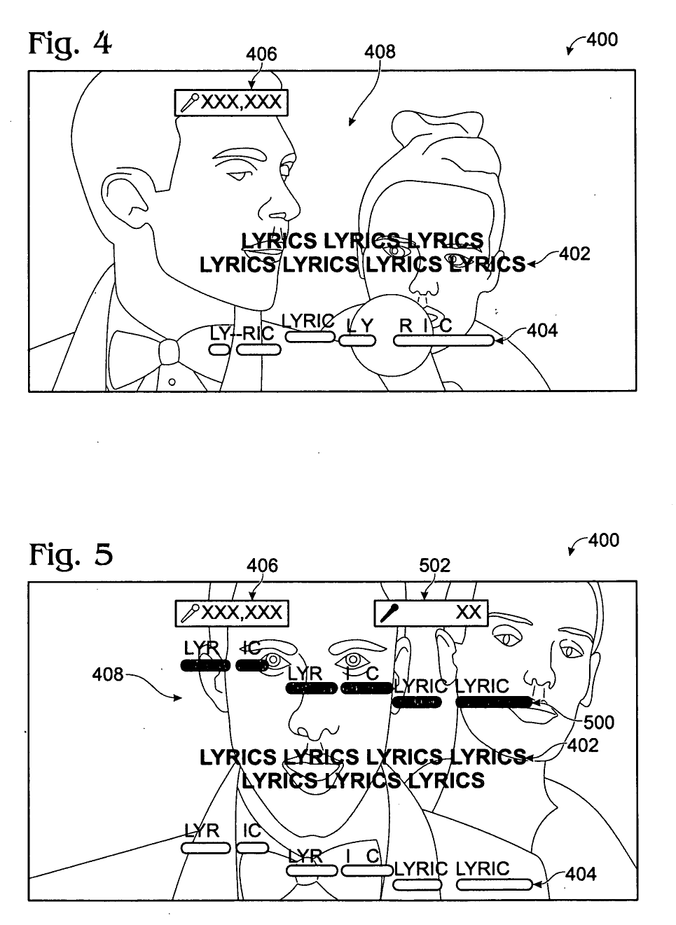

FIG. 3 presents a more detailed embodiment of a method 300 of controlling a microphone-based video game via a microphone. Method 300 comprises, at 302, presenting a video game with a first number of players. Where the first number of players is zero (i.e. where no players are currently playing the game), presenting the video game may comprise operating the video game in a background entertainment mode where music videos, movies, or other entertainment items are presented on a display. On the other hand, where the first number of players is greater than zero (i.e. where one or more current players are playing the game), presenting the video game may comprise presenting a user interface for the video game that shows the game action, scoring information for each current player, etc. FIG. 4 shows a screen shot 400 of a display showing a video game user interface that comprises a set of lyrics 402, a first player representation 404, and a first player score 406 displayed over a music video 408.

Continuing with FIG. 3, method 300 next comprises, at 304, receiving a first set of signals from a microphone not currently actively joined to the game, wherein the first set of signals includes motion signals from a motion sensor on the microphone. In response to receiving the first set of motion signals, method 300 comprises, at 306, adding a representation of an additional player to the video game without interrupting normal game playback for any other players currently playing the video game. For example, referring to FIG. 5, upon receipt of the set of signals from the microphone, a second player representation 500 and second player score 502 is added to the video game upon receipt of the first set of signals, without stopping normal playback of the video game. Therefore, the continuity of the first player's playing experience is not interrupted by the addition of the second player.

If the additional player is the first player to join the game, then, at 308, method 300 comprises changing the presentation of the video game from a background entertainment mode to an active mode. A background entertainment mode, for example, may be a video game mode that is configured to entice potential players to pick up a microphone, and thereby be automatically joined to the game. Such a mode may be configured to play music videos, to play a trailer for the microphone video game, or to present any other suitable content. In any case, whether the additional player is a first player or is joining other current players, method 300 next comprises, at 310 presenting the video game with a second number of players.

Next, method 300 comprises, at 311, receiving a second set of signals from the microphone during game play, wherein the second set of signals comprises one or more of voice signals and motion signals. Then, at 312, method 300 comprises detecting a predetermined control pattern that is distinguishable from the vocal and gesture inputs received during normal game play. The predetermined control pattern represents a pattern that a player may input into the microphone via gestures, vocals or other audio input (e.g. hitting microphone with hand), and/or combinations thereof, that is configured to cause a pre-determined control action to be performed by the video game system. For example, as shown at 314, in response to the predetermined control signal, method 300 may comprise changing a play/pause state of music being played in a video game. As a more specific example, if a player wishes to pause playback of a video game, a player may shake the microphone. Therefore, in this example, the control signal comprises a shaking gesture performed by a currently in-use, as opposed to inactive, microphone. Likewise, once the player wishes to resume play, the player may again shake the microphone to cause playback to proceed. It will be understood that a control signal also may be an audio signal, and/or a combination of audio and motion signals. Further, it will be understood that the specific examples of control signals herein are described for the purpose of example, and are not intended to be limiting in any manner.

Continuing with FIG. 3, method 300 next comprises, at 316, receiving a third set of signals from the microphone, wherein the third set of signals comprise motion signals, wherein the third set of signals represent a change of state of the microphone from an in-use state to an inactive state. Then, method 300 comprises, at 318, detecting in the third set of motion signals one or more signals representing a period of inactivity that lasts longer than a threshold period. If a period of inactivity longer than a threshold period is detected, then method 300 comprises, at 320, removing the representation of the additional player without interrupting normal game playback for any other players currently playing the video game.

The threshold period may have any suitable duration. For example, in some embodiments, it may be desired to allow players to place a microphone down on a table or other surface to get a snack or drink, to use the restroom, etc. without removing the player from the game, as removing the player from the game may have various consequences, such as the removal of the player's score from the game, that are undesirable to a player who wishes to take only a brief break from the game. In this example, a suitable threshold duration may comprise a duration of 2 minutes or less. In a more specific example, a threshold duration of 30-60 seconds, such as 45 seconds, may be used. It will be understood that these specific times and ranges of times are presented for the purpose of example, and are not intended to be limiting in any manner. Further, it will be understood that a video game system may utilize any subset of the various control signals and responses described in the context of FIG. 3 (e.g. add player, stop/start playback, remove player).

The removal of the player from the game upon detecting a period of inactivity in the set of motion signals from the microphone may be performed in any suitable manner. For example, referring to FIG. 5, if the second player leaves the game by placing the microphone down for a period of time longer than the threshold duration, then the representation 500 of the player and the score 502 of the player may be removed from the display of the video game. In this manner, the display may revert back to the state shown in FIG. 4, where a single player representation 404 and score 406 are shown on the display. Further, if the player that is removed from the game at 320 is the last player in the game, then, in some embodiments, method 300 may additionally comprise, at 322, changing the game from an active mode to a background entertainment mode.

While the examples of FIGS. 4 and 5 show a video game change between a one player mode and a two player mode, it will be understood that the concepts disclosed herein may be utilized to add any suitable number of players to a microphone-based video game, up to the maximum number allowed by the game.

FIG. 6 shows another embodiment of a method 600 of controlling a presentation of a microphone-based video game via a microphone. Unlike methods 200 and 300, which involved controlling the addition/removal of players and also a play/pause state of the playback of the video game, method 600 involves controlling an action performed by a “virtual audience” displayed by a microphone-based video game on a display during game play. First, method 600 comprises, at 602, presenting a microphone-based video game on a display, and, at 604, displaying a video representation of an audience on the display. For example, the video game may be designed to put a player in the perspective of a singer on stage singing to the virtual audience shown on the display.

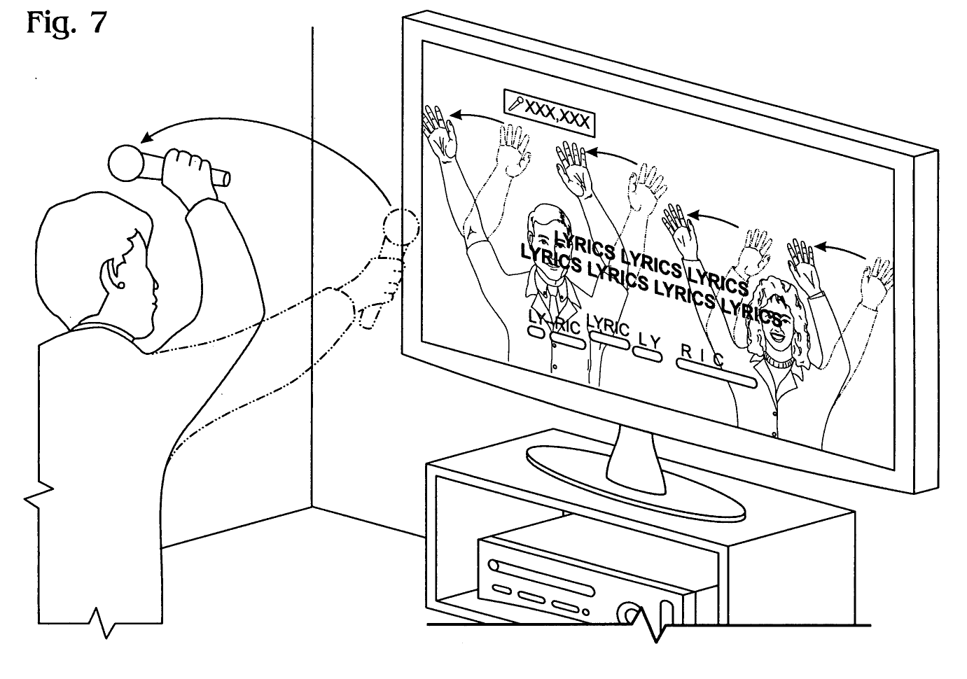

Next, at 606, method 600 comprises receiving a set of signals from a microphone in use by a player, wherein the set of signals comprises one or more of a representation of a microphone gesture (e.g. motion signal 608) and a representation of a vocal sample (e.g. voice signal 610) for the virtual audience to repeat back to the player. The motion signal may comprise a microphone gesture repeated by the player, such as a player waiving his or her arms back and forth. This is illustrated in FIG. 7, which shows a virtual audience mimicking a gesture made by a player. Two members of the virtual audience are shown for simplicity; however, many more may be displayed (e.g. a stadium-sized virtual audience). Likewise, the voice signals may comprise a vocal segment, such as a phrase from a song, sung into the microphone by the player.

Such gestures and/or vocal samples may be input at a specified portion in the game designated for such interaction with the virtual audience, or may be performed spontaneously by a player at any point in the game. Where the gestures and/or vocal samples are performed spontaneously, the gestures and/or vocal samples may further comprise a pre-selected control signal that triggers the video game to display the audience mimicking the player's gesture and/or vocal input. For example, in the case of a gesture, the repetition of a gesture more than a threshold number of times may be configured to cause the video game to display the audience mimicking the action. Likewise, in the case of the vocal input, a gesture used in combination with the vocal input, such as the player pointing the microphone toward the display screen after singing a desired vocal phrase, may be configured to cause the video game to repeat the vocal sample.

In the case of the vocal sample, the duration of the sample to be played back may be determined in any suitable manner. For example, in some embodiments, a vocal sample of a fixed time length may be played back to the player. In other embodiments, a vocal sample may be parsed to locate a vocal pause that determined to be between spoken or sung phrases (e.g. lasts a predetermined duration, is preceded by a drop in vocal tone or pitch, etc.), and playback may begin at the vocal pause. It will be understood that these methods for determining where to begin playback of a vocal sample are presented for the purpose of example, and are not intended to be limiting in any manner.

Continuing with FIG. 6, after receiving the set of signals from the microphone, method 600 next comprises, at 612, controlling the representation of the audience to display the audience repeating the vocal sample and/or gesture (other than the control gesture that triggers the vocal sample) to the player. For example, at 614, repeating may comprise presenting the audience repeating a gesture performed by a player, and/or at 616, presenting the audience repeating the vocal sample.

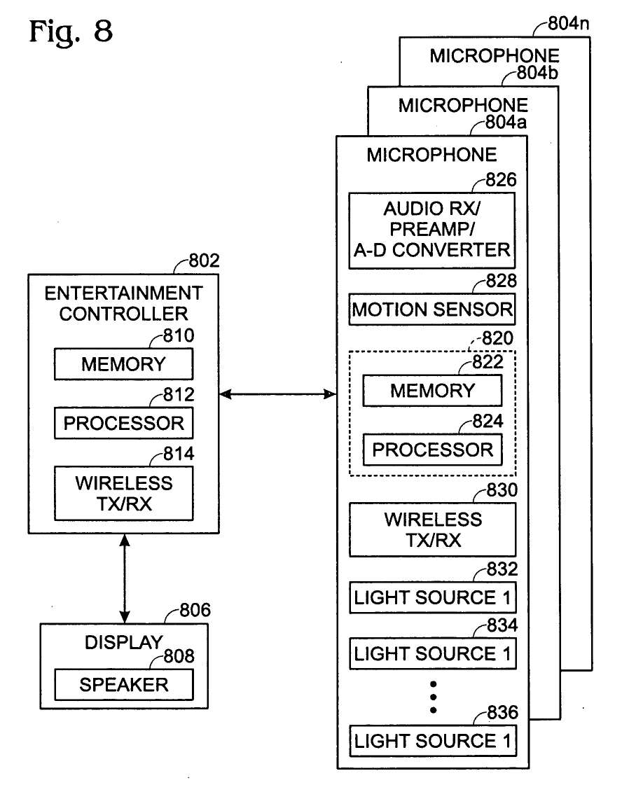

FIG. 8 shows a block diagram of an embodiment of a video game system 800 suitable for use with the video game presentation embodiments disclosed herein. Video game system 800 comprises an entertainment controller 802 in communication with a plurality of microphones 804a, 804b, 804n, and with a display system 806. Entertainment controller 802 comprises various components, including but not limited to memory 810, a processor 812, and a wireless transmitter/receiver 814. Entertainment controller 802 is configured to control a presentation of an interactive content item, such as a karaoke game. Thus, the entertainment controller 802 may be configured to control the display of lyrics and/or a music video for a karaoke selection on the display system 806, to control the playback of an audio portion of the karaoke selection via one or more speakers 808 on the display system (or via other speakers located elsewhere in the system), etc. It will be understood that the entertainment controller 802 may communicate with the microphone 804 and the display system 806 wirelessly and/or via one or more cables or the like connecting the devices. Further, it will be appreciated that the entertainment controller, microphone 804 and display system 806 may be connected directly to one another, or may communicate over a network.

The entertainment controller 802 may comprise programs or code stored in memory 810 and executable by the processor 812 to perform the various video game control methods disclosed herein. Generally, programs include routines, objects, components, data structures, and the like that perform particular tasks or implement particular abstract data types. The term “program” as used herein may connote a single program or multiple programs acting in concert, and may be used to denote applications, services, or any other type or class of program.

Continuing with FIG. 8, each microphone 804 comprises a microphone controller 820 with memory 822 and a processor 824. Each microphone 804 also comprises an audio input 826 configured to receive a vocal input from a player. The audio input 826 may include components such as an audio transducer, a preamp or other amplification stages, an analog-to-digital converter, and/or any other suitable components. Each microphone 804 further comprises one or more motion sensors 828 configured to detect a player gesture, and to provide a signal based upon the gesture to the microphone controller 820 as a gesture input. The microphone 804 further comprises a wireless receiver/transmitter 830 to enable the microphone to communicate wirelessly with the entertainment controller 802. In other embodiments, the microphone 804 may be configured to communicate with the entertainment controller 802 via a cable that connects each microphone 304 to the entertainment controller 802.

In some embodiments, the microphone 804 may further comprise a plurality of light sources, shown as light source 1, light source 2, and light source n at 832, 834, and 836, respectively, configured to provide an additional player feedback mechanism. Each light source may comprise any suitable components, including but not limited to light bulbs, LEDs, lasers, as well as various optical components to direct light to outlets located at desired locations on the microphone casing.

It will be appreciated that the configurations and/or approaches described herein are exemplary in nature, and that these specific embodiments or examples are not to be considered in a limiting sense, because numerous variations are possible. The specific routines or methods described herein may represent one or more of any number of processing strategies such as event-driven, interrupt-driven, multi-tasking, multi-threading, and the like. As such, various acts illustrated may be performed in the sequence illustrated, in parallel, or in some cases omitted. Likewise, the order of any of the above-described processes is not necessarily required to achieve the features and/or results of the embodiments described herein, but is provided for ease of illustration and description. The subject matter of the present disclosure includes all novel and nonobvious combinations and subcombinations of the various processes, systems and configurations, and other features, functions, acts, and/or properties disclosed herein, as well as any and all equivalents thereof.

1. A method of operating a microphone-based video game, comprising:
presenting the video game on a display;
receiving one or more motion sensor signals from a microphone comprising a motion sensor;
detecting a change of state of the microphone between an in-use state and an inactive state based upon the one or more motion sensor signals received from the microphone; and
in response to the change of state of the microphone, changing a number of representations of players displayed in the video game.

2. The method of claim 1, wherein the change of state is a change from an inactive state to an in-use state, and wherein changing the number of representations of players comprises changing the number of representations of players from zero players to one player.

3. The method of claim 2, further comprising changing a mode of the video game from a background entertainment mode to an active mode upon detecting the change of state.

4. The method of claim 1, wherein the change of state is from an inactive state to an in-use state, and wherein changing the number of representations of players displayed in the video game comprises adding a representation of a new player to the video game without interrupting normal game playback for other players currently playing the game.

5. The method of claim 1, wherein the change of state is a change from an inactive state to an in-use state, and wherein the one or more motion sensor signals correspond to a lifting of the microphone from a surface after a period of inactivity longer than a threshold period.

6. The method of claim 1, wherein the change of state is a change from an in-use state to an inactive state, and wherein detecting a change of state comprises detecting from the one or more motion sensor signals a period of inactivity longer than a threshold period.

7. The method of claim 1, wherein the change of state is a change from an in-use state to an inactive state, and wherein changing the number of representations of players displayed in the video game comprises removing a representation of a departing player from the video game without interrupting normal game playback for other players currently playing the video game.

8. The method of claim 1, wherein the change of state is a change from an in-use state to an inactive state, wherein changing the number of representations of players displayed in the video game comprises changing the number of representations of players from one player to zero players, and further comprising changing a mode of the video game from an active mode to a background entertainment mode upon detecting the change in state.

9. The method of claim 1, further comprising displaying a representation of an audience during presentation of the video game, receiving a set of signals that comprises signals representing a repeated gesture by a player, and in response, controlling the representation of the audience to display the audience repeating the repeated gesture.

10. The method of claim 1, further comprising displaying a representation of an audience during presentation of the video game, receiving a set of signals that comprises a vocal input by a player followed by a gesture comprising a pointing of the microphone toward the display, and in response, controlling the representation of the audience to display the audience repeating the vocal input.

11. A method of operating a microphone-based video game, comprising:
presenting on a display the video game with a first number of players represented in the video game;
receiving a first set of signals from a microphone comprising a motion sensor, wherein the first set of signals comprises motion signals;
in response to the first set of signals, adding a representation of an additional player to the video game without interrupting normal game playback for any other players currently in the game;
during game play, receiving a second set of signals from the microphone;
detecting a predetermined control pattern in the set of signals;
in response to the predetermined control pattern, changing a play/pause state of music being played in the video game;
receiving a third set of signals from the microphone, wherein the third set of signals comprises motion signals;
detecting in the third set of motion signals a period of inactivity longer than a threshold period; and
in response to detecting the period of inactivity longer than the threshold period, removing the representation of the additional player from the video game without interrupting normal game playback for other any players currently in the game.

12. The method of claim 11, wherein adding the representation of the additional player to the video game comprises adding the representation of the additional player while other players are currently playing the game.

13. The method of claim 11, wherein adding the representation of the additional player to the video game comprises changing a number of players of the game from zero to one, and further comprising changing a mode of the video game from a background entertainment mode to an active mode

14. The method of claim 11, further comprising displaying a representation of an audience during presentation of the video game, receiving a set of signals that comprises signals representing a repeated gesture and/or vocal sample made by a player, and in response, controlling the representation of the audience to display the audience repeating the repeated gesture and/or vocal sample.

15. The method of claim 11, wherein the signals in the second set of signals comprise motion signals from a motion sensor located on the microphone.

16. The method of claim 11, wherein the signals in the second set of signals comprise voice signals from the microphone.

17. A method of operating a microphone-based video game, comprising:
displaying on a display a video representation of an audience to a player;
receiving a set of signals from a microphone configured to provide a signal for the video game, the set of signals comprising signals that represent one or more of a gesture and a vocal sample made by the player;
in response to the set of signals, controlling the representation of the audience to cause the audience to perform a representation of the gesture and/or vocal sample made by the player.

18. The method of claim 17, wherein the set of signals comprises signals that represent a repeated gesture by a player, and wherein controlling the representation of the audience comprises displaying the audience performing the repeated gesture.

19. The method of claim 17, wherein the set of signals comprises a vocal sample, and wherein controlling the representation of the audience comprises displaying one or more of a video representation of the audience repeating the vocal sample and an audio representation of the audience repeating the vocal sample.

20. The method of claim 19, wherein the set of signals further comprises a set of signals from a motion sensor representing a pointing of the microphone toward the display.
